(19) United States
(12) Patent Application Publication
(10) Pub. No.: US 2014/0025440 A1
(43) Pub. Date: Jan. 23, 2014

(54) AGGREGATED PERFORMANCE INDICATOR STATISTICS FOR MANAGING FLEET PERFORMANCE

(71) Applicants: Paresh L. Nagda, Pleasanton, CA (US); Beena Umashankkar, Fremont, CA (US)

(72) Inventors: Paresh L. Nagda, Pleasanton, CA (US); Beena Umashankkar, Fremont, CA (US)

(21) Appl. No.: 13/552,064

(22) Filed: Jul. 18, 2012

(51) Int. Cl. G06Q 10/08

(52) U.S. Cl. 705/7.38

(57) ABSTRACT

Systems, methods, and media for managing fleet performance with aggregated performance indicator statistics are provided herein. Mobile assets may provide sensor data to a data center. The data center may determine performance indicators based at least in part on the sensor data. The data center may calculate statistics based at least in part on the performance indicators. The data center may aggregate the calculated statistics.

### FIELD OF THE TECHNOLOGY

Embodiments of the disclosure relate to managing performance of a fleet, and more specifically, to managing performance based at least in part on mobile asset performance indicator statistics.

### BACKGROUND OF THE DISCLOSURE

The global positioning system (GPS) is a space-based navigation system including a network of orbiting satellites (called NAVSTAR). Although established for military applications by the U.S. Department of Defense, in the 1980s the system was made available for civilian use. When locked onto the signal of at least three satellites, a GPS receiver calculates a 2D position (latitude and longitude). When locked onto the signal of at least four satellites, a GPS receiver may calculate a 3D position (latitude, longitude, and altitude), subject to the accuracy of map information in the receiver and accuracy of the location calculation. The GPS also provides highly accurate timestamps.

When used in a vehicle and once a GPS navigation system has determined its location using signals from the orbiting satellites, the GPS navigation system displays a map and instruct a driver by providing graphical information, as well as via text or speech on how to get to a destination. GPS navigation systems are used to navigate in unfamiliar areas with reduced risk of getting lost, subject to the accuracy of the location information and maps used by the GPS navigation system. Different businesses, such as shipping and distribution companies, cargo systems companies, maintenance, repair and operations (MRO) organizations, service vehicle operators, cable television operators, schools, construction companies, and the like may operate a fleet of mobile assets, such as cars or trucks, which may make use of navigation systems.

### SUMMARY OF THE DISCLOSURE

According to some embodiments, the present technology may be directed to methods for managing mobile assets & workers. The methods may comprise: receiving, via software stored in a memory and executed by a processor, location information and sensor data; determining, via software stored in a memory and executed by a processor, at least one performance indicator; calculating, via software stored in a memory and executed by a processor, statistics for the at least one performance indicator; and aggregating the calculated statistics.

According to other embodiments, the present technology may be directed to a systems for managing mobile assets. The system may comprise: a processor; and a memory communicatively coupled with the processor, the memory storing software which when executed by the processor performs a method comprising: receiving location information and sensor data; determining at least one performance indicator; calculating statistics for the at least one performance indicator; and aggregating the calculated statistics.

According to some embodiments, the present technology may include computer-readable storage media. The computer-readable storage media may have embodied thereon a program, the program being executable by a processor to perform a method for managing mobile assets, the method comprising: receiving location information and sensor data; determining at least one performance indicator; calculating statistics for the at least one performance indicator; and aggregating calculated the statistics.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a block diagram illustrating a system for practicing aspects of the present technology.

FIG. 2 is a schematic illustration of a computing device architecture.

FIG. 3 is a schematic illustration of a data center.

FIG. 4 is a schematic illustration of a computer.

FIG. 5 is a flowchart of a method for operating a computing device.

FIG. 6 is a flowchart of a method for operating a data center.

FIG. 7 illustrates a bar chart.

FIG. 8 shows a column chart with trend lines.

FIG. 9 depicts a spreadsheet.

FIG. 10 represents another column chart with trend lines.

FIG. 11 portrays still another column chart with trend lines.

FIG. 12 illustrates another bar chart.

FIG. 13 shows yet another bar chart.

FIG. 14 depicts another column chart with trend lines.

FIG. 15 represents still another column chart with trend lines.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown in block diagram form only in order to avoid obscuring the disclosure.

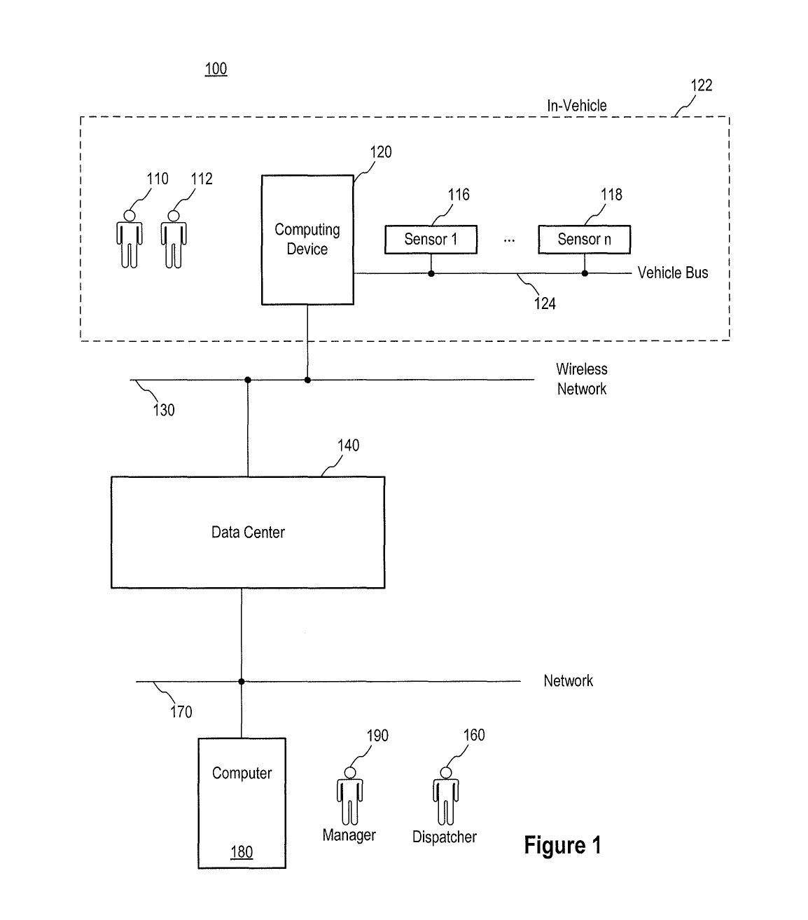

FIG. 1 is a schematic illustration of a system in accordance with embodiments of the present invention. System 100 may include one or more assets (e.g., vehicle 122), data center 140, and computer 180. Assets may include any type of vehicle such as a car, truck, motor vehicle (e.g., delivery truck, field service vehicle, school bus, company car, etc.), heavy equipment (e.g., garbage truck, cherry picker, street sweeper, bulldozer, crane, tractor, etc.), and/or any other type of mobile asset (e.g., an airplane, a helicopter, a mobile phone, a smartphone, tablet computer, subnotebook computer, other mobile computing device, and the like). Any number of assets may be included in system 100, and may be in communication with data center 140 over a network (e.g., wireless network 130). One asset, vehicle 122, is a representative asset. A fleet may, for example, be any grouping of assets, driver 110, co-driver 112, dispatcher 160, manager 190, and/or other operator/user. In some embodiments, a fleet includes a plurality of assets, associated drivers 112, and assigned dispatchers 160.

Vehicle 122 may be operated by driver 110 and optionally co-driver 112. Each asset in system 100, including vehicle 122, may be provided with a computing device 120. Driver 110 and/or co-driver 112 interface with computing device 120 to communicate with data center 140, as will be described further below. Computing device 120 may provide navigation and/or tracking functionality. Computing device 120 may include sensors and/or may be in communication with sensors in the asset, such as vehicle 122. For example, computing device 120 may be in communication with sensors 116-118. Sensors 116-118 may include, for example, one or more seat belt sensors that may detect whether seat belt(s) within the vehicle are latched or open, door sensors that may detect whether a particular door (e.g., a passenger or driver door) is open, temperature sensors, fuel level sensors, accelerometer (which for example senses acceleration, deceleration, and/or hard turning/cornering), timers to log time intervals (e.g., hours on the road), vehicle ignition sensors to indicate if the vehicle ignition is on, door locked/unlocked sensors, airbag deployment sensors, impact/vehicle collision sensors, vehicle speed sensors, and direction sensors. Other sensors may also be used. Sensors 116-118 may be used with control circuitry and actuators (not shown) to control vehicle ignition (e.g., start or turn off engine), adjust temperature in a truck or van, adjust vehicle speed (e.g., slow down), unlock doors, and the like. Vehicle bus 124 may couple sensors 116-118 with computing device 120. Vehicle bus 124 may be a wireless and/or wired bus for communicating data, commands, and optionally provide power (e.g., Controller Area Network (CAN) bus, On-Board Diagnostics (OBD-II), J-Bus, power bus, RS-232, RS-422, RS-484, universal serial bus (USB), I-Wire, and custom bus). Other types of communication interfaces between computing device 120 and sensors 116-118 may also be used.

Computing device 120, which may be a mobile device, may include a global positioning system (GPS) receiver and may provide navigation system functionality. Computing device 120 may also provide messaging functionality. Computing device 120 generally is configured to communicate information about driver 110 and/or vehicle 122 to data center 140, and receive information from data center 140. For example, computing device 120 may provide sensor data and/or location information about vehicle 122 to data center 140, allowing dispatcher 160 or manager 190 to be notified of a state (or condition) and/or location of vehicle 122, or indeed the state (or condition) and/or location of any of the assets in system 100.

In embodiments of the present invention, computing device 120 may determine a geographical location of vehicle 122, for example, using a Global Positioning System (GPS) receiver. In some embodiments, computing device 120 may display a notification, which may be a safety monitoring notification, to driver 110 and/or co-driver 112 on a display. Information including, for example, sensor data may be sent from computing device 120 over wireless network 130 to data center 140. In some embodiments, computing device 120 and data center 140 may communicate using messages.

Wireless network 130 may be a local-area network (e.g., Wi-Fi (IEEE 802.11)), and/or wide-area network (e.g., “3G” (i.e., International Mobile Telecommunications-2000 (IMT-2000) (e.g., 3GPP Long Term Evolution (LTE), High-Speed Downlink Packet Access (HSDPA), High-Speed Uplink Packet Access (HSUPA), etc.)), “4G” (e.g., LTE Advanced and WirelessMAN-Advanced), WiMAX (IEEE 802.16m), CDMA2000 (e.g., IX, 1xRTT, EV-DO Rev. 0, EV-DO Rev. A, and EV-DO Rev. B), global system for mobile communications (GSM) (e.g., general packet radio service (GPRS), and enhanced data rates for GSM evolution (EDGE) or Enhanced GPRS (EGPRS)), integrated digital enhanced network (iDEN), wideband integrated digital enhanced Network (WiDEN), advanced mobile phone system (AMPS), total access communication system (TACS), Extended Total Access Communication System (ETACS), Universal Mobile Telecommunications System (UMTS), and the like). Any other network suitable for communicating between computing device 120 and data center 140 may also be used.

Data center 140 may be configured to receive and/or transmit information over wireless network 130, store information, run applications, and/or provide information to external devices or locations. Dispatcher 160, manager 190, or other user may utilize data stored at data center 140 to view locations of assets in system 100, and in embodiments of the present invention, may utilize data stored at or communicated to data center 140 to manage (e.g., data analysis and reporting) vehicle 122 (and/or driver 110), or other assets (and/or users) in system 100. Data center 140 may also be connected to and transfer data over network 170. Network 170 may be a wired (e.g., twisted pair, coaxial cable, optical fiber, etc.) and/or wireless (e.g., terrestrial microwave, communications satellites, cellular and PCS systems, wireless LANs, and/or infrared communications) computer network (e.g., the Internet). Although depicted as separate networks in FIG. 1, in some examples, networks 170 and 130 may be the same network.

Computer 180 may be a workstation, computer, notebook computer, subnotebook computer, netbook computer, tablet computer, smart phone, personal digital assistant (PDA), and the like. Generally, computer 180 represents a computer through which a user, such as manager 190, may communicate with data center 140. Computer 180 and/or data center 140 may be configured to provide data analysis and reporting, which may be queried and/or viewed using computer 180. Computer 180 may be located in the same facility as or at a location remote from data center 180.

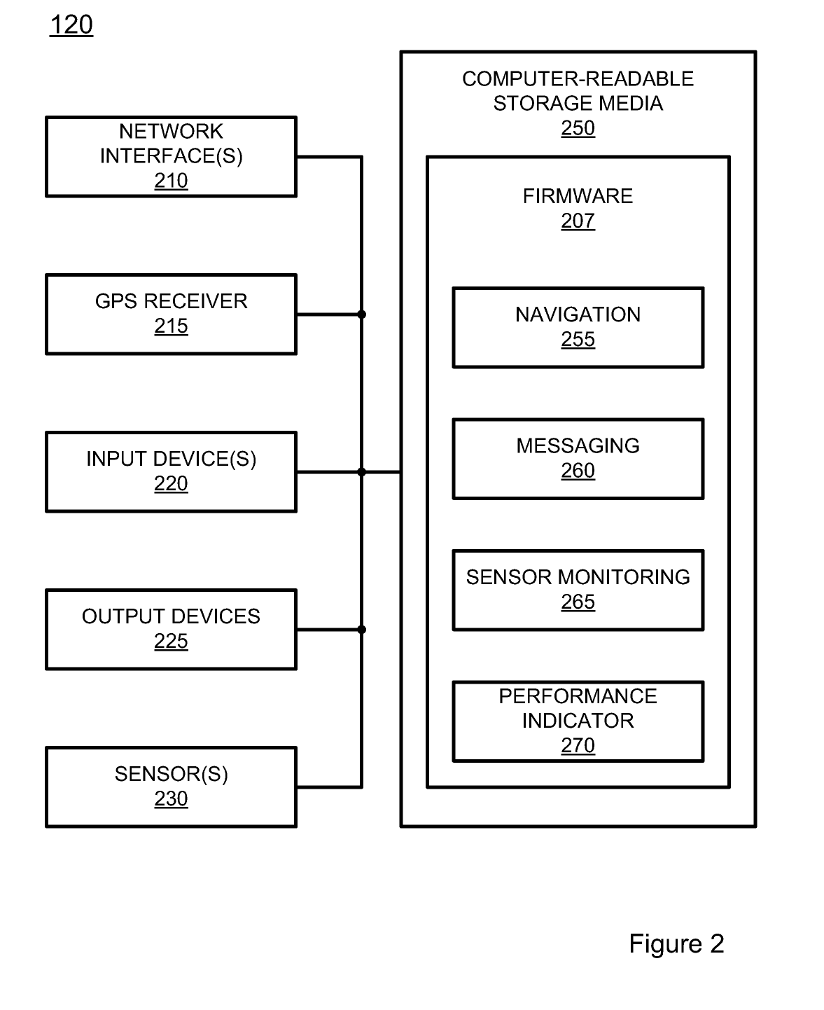

FIG. 2 is a schematic illustration of an example computing device arranged in accordance with embodiments of the present invention. The computing device 120 of FIG. 2 may for example be used in vehicle 122 of FIG. 1. Computing device 120 may include firmware 207 that may control operation of various components of computing device 120. Instead of firmware 207, in some examples software may be used to control components of computing device 120, in which case one or more processors and computer-readable mediums including executable instructions may be provided to perform the below functionalities, and in some examples combinations of firmware and software may be used.

Computing device 120 may also include network interface(s) 210. For example, computing device 120 may include one network interface for connecting to wireless network 130 of FIG. 1, and another network interface for connecting to vehicle bus 124 of FIG. 1. Referring again to FIG. 2, computing device 120 may further include a GPS receiver 215, which may be used to receive GPS signals. Computing device 120 may also include one or more input devices 220 and one or more output devices 225. Input and output devices may include, for example, a keyboard, mouse, trackball, touchpad, microphone, touch screen, flat panel, electronic ink display, indicator lights, speaker, and/or the like. Computing device 120 may further include one or more sensors 230. Sensors 230 may be configured to monitor some aspect of vehicle 122 of FIG. 1, and may be in communication with vehicle bus 124 in some examples. Accordingly, sensors for monitoring performance of vehicle 122 may be internal or external to computing device 120. Settings for sensors 230 may be provided by firmware 207 in accordance with configuration settings.

Computing device 120 further includes computer-readable storage media 250. Computer-readable storage media 250 may be memory, such as one or more volatile memory devices (e.g., RAM, SRAM, etc.), non-volatile memory (e.g., FLASH, EEPROM, etc.), magnetic media (e.g., hard disk drive), and/or removable media (e.g., compact disc (CD), digital versatile disc (DVD), Blu-ray disc (BD), USB flash drive, secure digital (SD) memory card, secure digital high capacity (SDHC) memory card, etc.). Computer-readable storage media 250 may store firmware 207 and/or software. Firmware 207 may control components of computing device 120 to perform navigation 255, messaging 260, sensor monitoring 265, and optionally performance indicator determining 270. Although shown as a single firmware 207 block in FIG. 2, firmware 207 may be implemented in some examples as combinations of firmware and software in the same or different blocks.

Computing device 120 may include memory that may store, for example, messages, routes or other geographical information for use in navigation functionality, data received from sensors 116-118 (shown in FIG. 1), performance indicators (as will be described further below), or other data.

As understood by one of ordinary skill in the art, generally any combination of computer system components that may be used to provide the functionalities described herein may be used. The functionality may be implemented in hardware, firmware, software, or combinations thereof. In some embodiments, computing device 120 may be implemented using multiple separate devices in communication with one another (e.g., a GPS device may be provided separately from other components of the computing device 120).

Computing device 120 may perform navigation functionality, such as by displaying routes and current position on output device 225 (e.g., a display). In some embodiments, any function of a navigation system may be performed by computing device 120.

In some embodiments of the present invention, computing device 120 may determine at least some performance indicators based at least in part on data (or events) received from sensors 116-118. Performance indicators may include idle time, engine hours, drive time, stop time, miles driven, number of jobs completed in a predefined time period, time in yard, fuel economy, and the like. Idle time may be the time during which vehicle 122 does not move a predefined distance after a predefined amount of time. For example, the predefined distance may be in a range of 10-500 feet and the predefined amount of time may be in a range of 5 seconds to 30 minutes. Engine hours may be the total engine time for vehicle 120 and may be determined from an amount of time which elapses between an ignition on event and an ignition off event. Drive time may be the time during which vehicle 122 is moving. In some embodiments, the drive time may be determined based at least in part by subtracting the idle time from the engine hours. Stop time may be a time between an ignition off and an ignition on events.

Miles driven may be the total distance travelled by vehicle 122. The number of jobs completed in a predefined time period may be the number of visits to one or more associated sites, where a particular work unit (e.g., job) has an associated site (e.g., job site, pickup location, drop-off/delivery location, etc.). The predefined time period, for example, may be a half hour, hour, day, week, month, quarter, year, and the like. In some embodiments, the predefined time period is one day. Time in yard may be the time spent in one or more yards (e.g., garages, depots, lots, etc. for storage and/or maintenance). Fuel economy may be, for example, the number of miles driven per gallon, the number of kilometers driven per liter, and the like.

In some embodiments of the present invention, a unique identifier may be associated with computing device 120. The unique identifier may be a serial number, network address, tag, and the like associated with computing device 120. For example, a serial number may be combination of alphanumeric characters assigned by system 100. Tags may include geographical information and an attribute of an organization or industry/sector. For example, tags may be associated with a region, a whole or part of a business organization (e.g., company, subsidiary, etc.), or an industry/sector (e.g., construction, public or private transportation, waste collection, shipping, delivery, etc.). A region may, for example, be a geographic area within a continent, country, state/province, or municipality, a type of developed environment (e.g., urban, rural, suburban, suburban, exurban, micro-urban, etc.), and/or the like. A business organization may be a private or public entity which operates and/or maintains one or more groups of mobile assets (e.g., taxi company, an airline, public transit authority, construction company, shipping company, delivery company, waste collection company, school district, etc.) and/or associated operators and users (i.e., fleet).

Computing device 120 may provide messages to network interface 210, for example, for transmission to data center 140 of FIG. 1. Messages may include, by way of example and not limitation, f vehicle position, data received from sensors 116-118, performance indicators, a unique identifier associated with the computing device 120, and the like. Computing device 120 may receive messages from data center 140 and process the messages. In some embodiments, computing device 120 may receive new firmware, software, configuration information, and data through messages from data center 140. In some embodiments, a message may be a Short Message Service (SMS) text message, email, email file attachment, User Datagram Protocol (UDP) datagram, Transmission Control Protocol (TCP) packet, and the like.

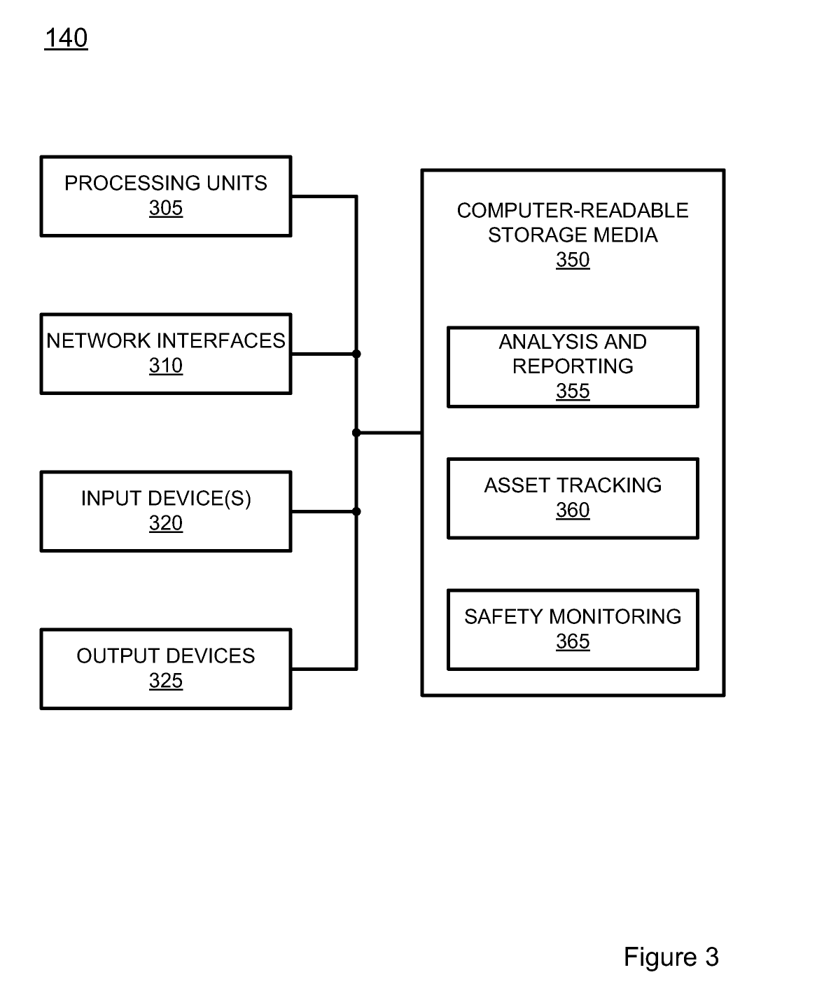

FIG. 3 is a schematic illustration of a portion of data center 140 (shown in FIG. 1) in accordance with embodiments of the present invention. Data center 140 may include one or more processing units 305. Processing units 305 may be one or more processors, such as but not limited to, an x86, SPARC, MIPS, PowerPC, ARM, or the like. Data center 140 may also include network interface(s) 310. For example, data center 140 may include one network interface for connecting to wireless network 130 of FIG. 1, and another network interface for connecting to network 170 of FIG. 1. Referring again to FIG. 3, data center 140 may also include one or more input devices 320 and one or more output devices 325, examples of which have been described above.

Data center 140 may further include computer-readable storage media 350. Computer-readable storage media 350 may include memory and may store firmware and/or software. Storage media 350 may be any of a variety of types of memory or storage media, examples of which have been described above with reference to computing device 120 of FIG. 2. Storage media 350, which may be a single medium or multiple media, may be encoded with executable instructions for performing various functionalities, which will be described further below. Storage media 350 may also store a datastore. Storage media 350 may operate in cooperation with processing units 305 to perform the described functionalities. That is, the processing units may execute the instructions stored in storage media 350. Examples of instructions that may be stored on storage media 350 include instructions for analysis and reporting 355, instructions for asset tracking 360, and instructions for safety monitoring 365. Although shown on the same storage medium 350 in FIG. 3, instructions 355-365, may be provided on separate media in some examples.

Data center 140 may include additional storage media in addition to storage media 350 shown in FIG. 3. Data may be stored in the additional storage media and/or in the storage media 350, which may include, for example, stored messages, stored sensor data, stored performance indicators, stored configuration files, account data, or other information. In some embodiments, stored performance indicators may include performance indicators for different units (e.g., divisions, subsidiaries, etc.) of a business organization. In further embodiments, stored performance indicators may include performance indicators for industry segments and different industries. For example, an industry may be segmented (i.e., industry segments determined) based at least in part on geography, size (e.g., in terms of revenue, number of employees, growth rate, etc.), and the like.

Generally, any combination of computer system components that may be used to provide the functionalities described herein may be used for data center 140. The functionality may be implemented in hardware, firmware, software, or combinations thereof.

Executable instructions for analysis and reporting 355 may include executable instructions for analyzing various of the data received by data center 140 and presenting tables, charts, graphs, or other arrangements of the data. Analyzing, for example, may include inspecting, cleaning, transforming, comparing, and modeling sensor data and/or performance indicators. Executable instructions for analysis and reporting 355 may include instructions for analyzing received sensor data from one or more of the assets in system 100 of FIG. 1 and performance indictors to generate and aggregate/collate statistics of performance indicators. In other examples, at least some determination of performance indicators may be performed by the asset (e.g., by the computing device 120 of FIG. 1), and executable instructions for analysis and reporting 355 may include instructions for receiving a message from computing device 120.

Executable instructions for asset tracking 360 may include instructions for receiving location information from multiple vehicles in a system, and storing, displaying, or otherwise utilizing the location information to track the assets in the system. Executable instructions for safety monitoring 365 may include instructions for analyzing received sensor data from one or more of the assets in system 100 of FIG. 1 to identify a potentially hazardous condition.

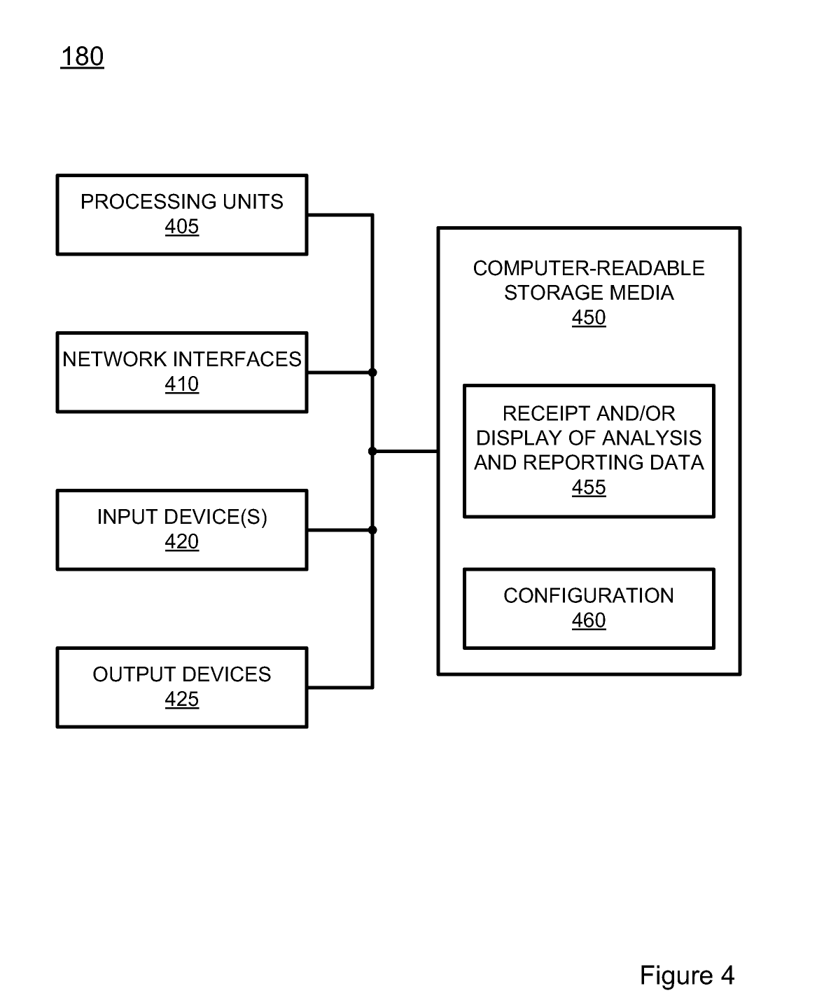

FIG. 4 is a schematic illustration of computer 180 (shown in FIG. 1) configured for communication with data center 140 in accordance with embodiments of the present invention. Computer 180 may include one or more processing units 405. Processing units 405 may be one or more processors, such as but not limited to, those described above with reference to processing units 305. Computer 180 may also include network interface(s) 410. For example, computer 180 may include a network interface for connecting to network 170 of FIG. 1. Referring again to FIG. 4, computer 180 may also include one or more input devices 420 and one or more output devices 425, examples of which have been described above.

Computer 180 further includes computer-readable storage media 450. Computer-readable storage media 450 may include firmware and/or memory. The storage may be any of a variety of types of memory or storage media, examples of which have been described above with reference to computing device 120 of FIG. 2. Storage media 450, which may be a single medium or multiple media, may be encoded with executable instructions for performing various functionalities, which will be described further below. Storage media 450 may operate in cooperation with processing units 405 to perform the described functionalities. That is, processing units may execute the instructions stored in storage media 450. Examples of instructions that may be stored on storage media 450 include instructions for receipt and/or display of analysis and reporting data 455 and instructions for receipt and/or configuration 460. Although shown on a same storage media 450 in FIG. 4, instructions 455 and 460, may be provided on separate media in some examples.

Computer 180 may include additional storage media in addition to storage media 450. Data may be stored in the additional storage media, and/or in storage media 450, which may include, for example, stored data received from data center 140, stored analysis and/or reports, or other data.

In some embodiments, computer 180 may perform the operations and/or functions described above as being performed by data center 140. Computer 180 may be any combination of computer hardware and/or software that implements the functionalities described herein.

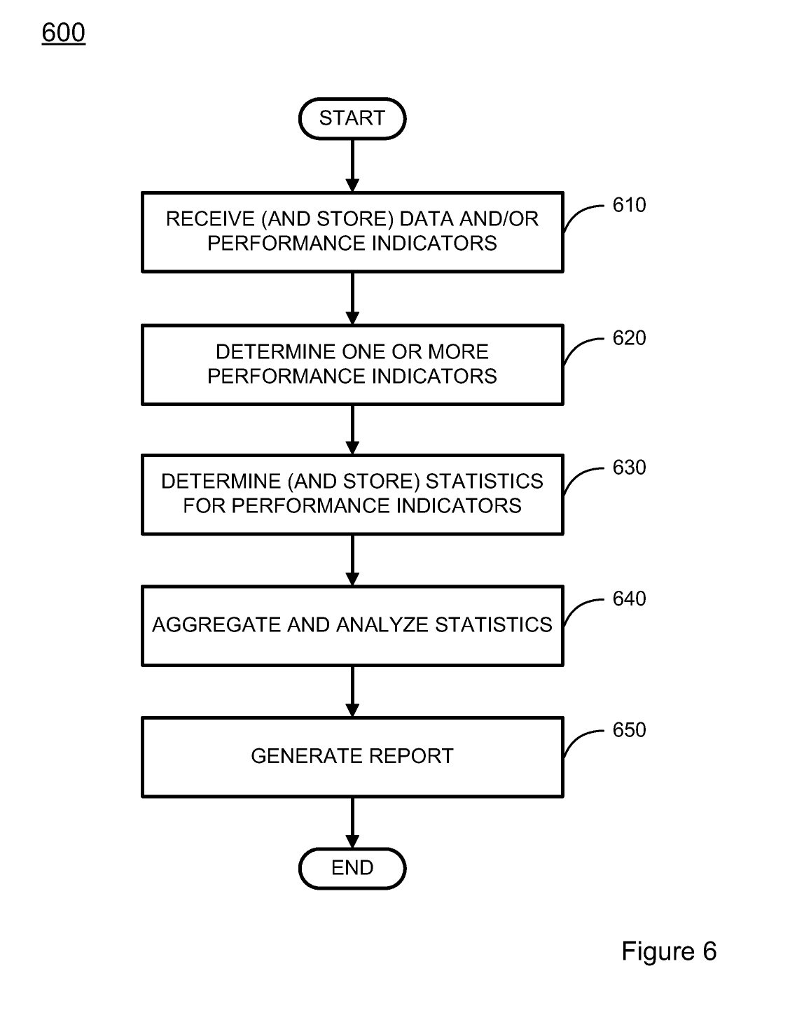

The executable instructions for receipt and/or display of analysis and reporting data 460 may include executable instructions for communicating with data center 140 to request and/or receive data or analysis generated by data center 140. A user of computer 180, such as manager 190 shown in FIG. 1, may request a report from data center 140. The data provided or analysis generated by data center 140 is further described below in relation to FIG. 6.

Executable instructions for configuration 460 may include instructions for providing configuration information to data center 140 and/or computing device 120. A user of computer 180, such as manager 190 shown in FIG. 1, may configure how and when sensor data and/or performance indicators are sent from computing device 120. The configuration provided through computer 180 may be used to configure one or multiple vehicles, for example, for all vehicles associated with a particular account. Accounts may, for example, be associated with a whole or part of a business organization. Accordingly, the configuration provided through computer 180 may result in adjustment of the configuration settings of firmware 207 of computing device 120.

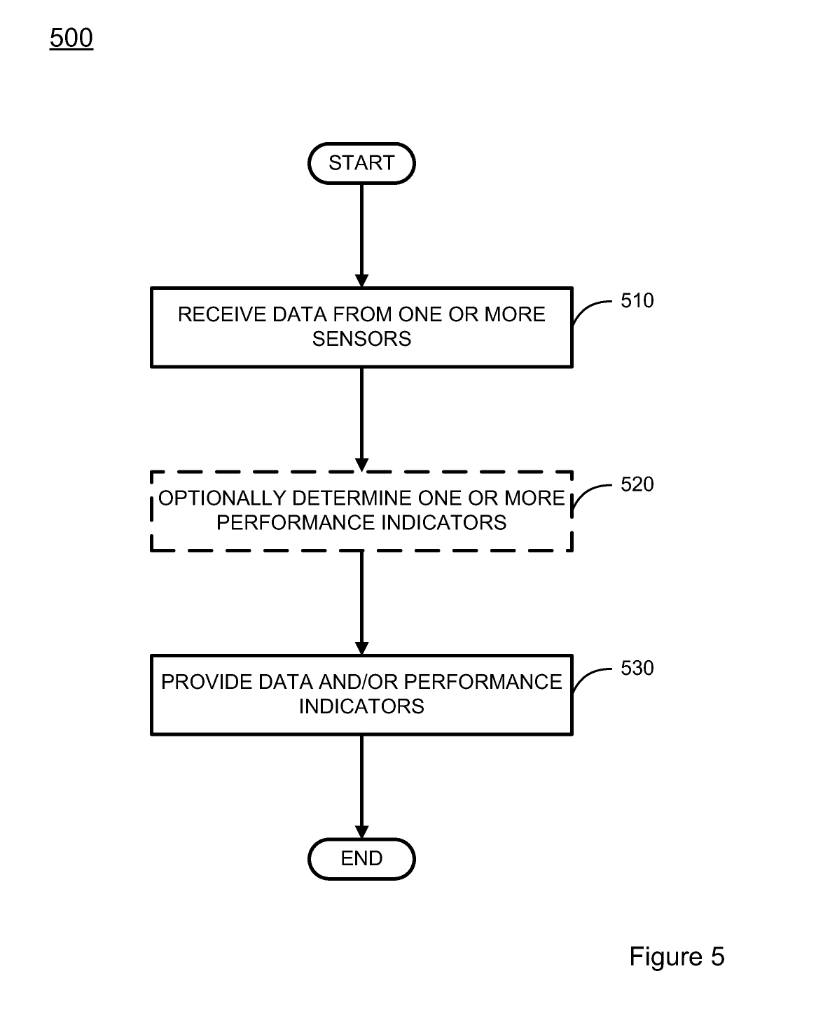

FIG. 5 is a flowchart of a method 500 for operating computing device 120 in accordance with embodiments of the present invention. Executable instructions for sensor data acquisition 265, performance indicator determination 270, and messaging 260 encoded in storage media of firmware 207 of computing device 120 may perform certain of the acts recited in FIG. 5. In other examples, the acts may be performed by other devices.

Referring again to FIG. 5, method 500 may begin at step 510 and receive data from one or more sensors 116-118. As described above, sensor data may include the speed (or velocity) of vehicle 122, changes in state of the ignition of vehicle 122 (e.g., turned on or off), odometer data, amount of vehicle 122 fuel consumed (and/or remaining), and the like. In some embodiments, time stamps (associated with events or sensor readings) may be included in the sensor data. In further embodiments, sensor data is sampled at predefined time intervals or at instances of events in accordance with configuration settings. For example, predefined time intervals may be in the range of every 10 seconds to 1 hour, and events may include when the ignition of vehicle 122 is turned on and off.

Method 500 may include step 520 of determining one or more performance indicators. Computing device 120 may optionally determine at least one performance indicator based at least in part on the sensor data.

At step 530, computing device 120 provides the sensor data and/or performance indicators. In some embodiments, computing device 120 may generate and send one or more messages including sensor data to data center 140. In further embodiments, computing device 120 may generate and send one or more messages including a performance indicator to data center 140. In additional embodiments, the one or more messages may also include a unique identifier.

FIG. 6 is a flowchart of a method 600 for operating data center 140 of FIG. 1 in accordance with embodiments of the present invention. Executable instructions for Analysis and Reporting encoded in storage media 350 of data center 140 may perform certain of the acts recited in FIG. 6. In other examples, the acts may be performed by other devices.

Referring again to FIG. 6, method 600 may begin at step 610 and receive sensor data from one or more of computing device 120 of FIG. 1. In some embodiments, sensor data is received in a message from one or more of computing device 120. In embodiments where computer device 120 determines at least one performance indicator, data center 140 may also receive a message including a performance indicator. In further embodiments, the messages from one or more of computing device 120 each include a unique identifier associated with each computing device 120. The unique identifier may be used to associate sensor data and/or performance indicators from each computing device with a country or region, a whole or part of a business organization, and/or an industry. The sensor data may be stored in computer-readable storage media 350.

At step 620 one or more performance indicators may be determined. Exemplary performance indicators and their determination are described above.

At step 630, statistics of the one or more performance indicators are determined. For example, the determined statistics may include a count (i.e., total number of data points), summation, mean, average, rolling average, standard deviation, variance, range, maximum, minimum, and the like. In some embodiments, the statistics may be determined according to a predefined time period (e.g., user-defined time period, day, week, month, quarter, year, etc.). In further embodiments, statistics may be determined for a single vehicle and/or a plurality of vehicles (i.e., fleet). The fleet may be grouped based at least in part on, for example, an associated country or region, whole or part of the same business organization, industry segments, and/or different industries. The determined statistics may be stored in computer-readable storage media 350.

At step 640 the determined statistics may be aggregated (or collated) and analyzed. In some embodiments, the statistics of the one or more performance indicators may be aggregated and analyzed with additional statistics. For example, additional statistics may be associated with performance indicators from a different region or country, one or more parts of the same business organization, one or more different business organizations within the same industry, one or more business organizations in another industry, and the like.

The additional statistics may be determined with data from an alternative data source (e.g., other than computing device 120) and may include statistics such as fuel costs, revenue per job, and the like. In some embodiments, the data sources may be from within a business organization or from a third party. For example, the third party may be an industry trade group, market research firm, non-governmental organization (NGO), government or state agency, and the like. In further embodiments, the additional statistics may be determined by data center 140 or may be provided by the third party. The additional statistics may be stored in computer-readable storage media 350.

At step 650, a report may be generated. In some embodiments, the report may present the aggregated statistics arranged in the rows and columns of a grid (e.g., spreadsheet). In further embodiments, the report may present the aggregated statistics numerically (e.g., as numeric data in tabular form) or graphically (e.g., in a column or bar chart, line chart, pie chart, area chart, scatter chart, surface chart, bubble chart, doughnut chart, etc.). A single vehicle and/or fleet(s) may be represented.

The graphical report of the aggregated statistics may, for example, enable manager 190 for one or more vehicles in a fleet to ascertain trends, make projections, set goals and determine progress toward the goals, determine the efficacy of training or other programs, determine optimal asset allocation, and the like. The graphical report may also, for example, enable manager 190 to evaluate specific makes, models, and model years of mobile assets in the fleet. Similarly, the graphical report may, for example, enable manager 190 to evaluate consumables such as fluids (e.g., fuel, brake fluid, coolant, refrigerant, etc.) and equipment (e.g., tires, filters, and other vehicle parts) from various sources/suppliers. The graphical report of the aggregated statistics may also present a comparison of a fleet of vehicles against peers in the same industry or different industry (i.e., benchmarking). Benchmarking is the process of comparing one's business processes and performance metrics to industry data and/or data from other industries. Insights into quality, time, and cost are accessible through presentation of the aggregated statistics.

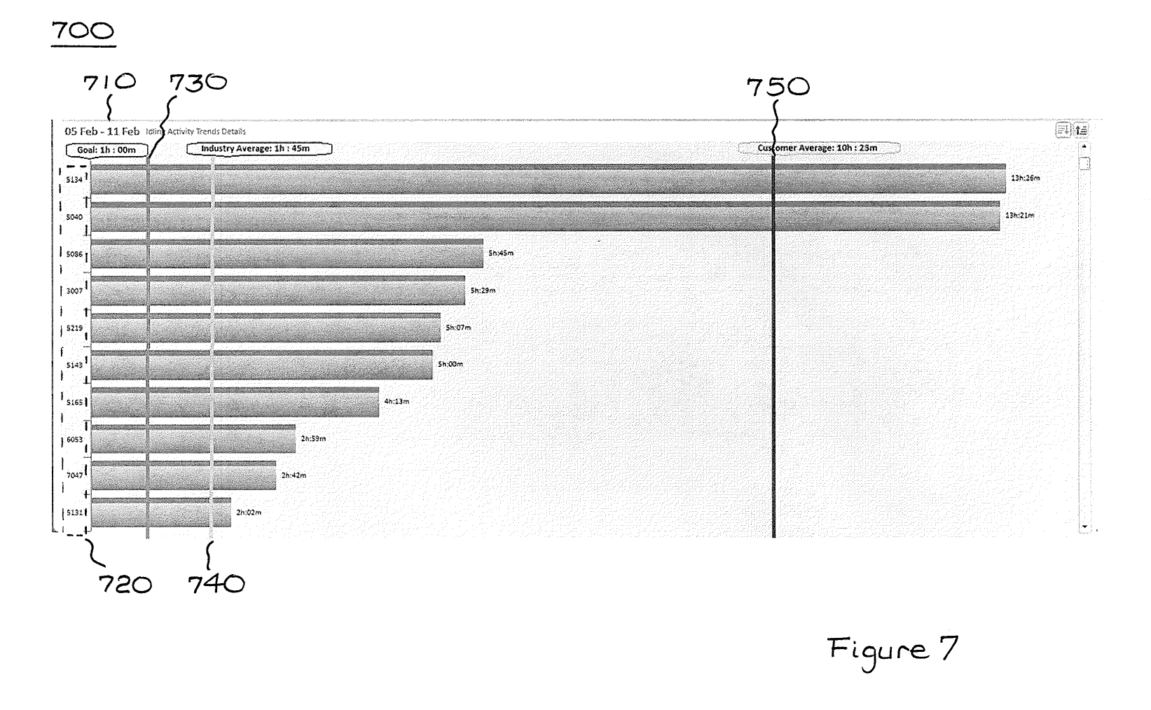

FIGS. 7-15 illustrate various embodiments of the graphical report. FIG. 7 illustrates a bar chart 700 according to embodiments of the present invention. Bar chart 700 represents a performance indicator, idle time, for a predefined time period 710 for a plurality of computing devices 720. Vertical lines represent each of goals 730, industry/sector average 740, and organization (i.e., fleet) average 750. Vertical lines 730-750 may make analysis or comparisons easier.

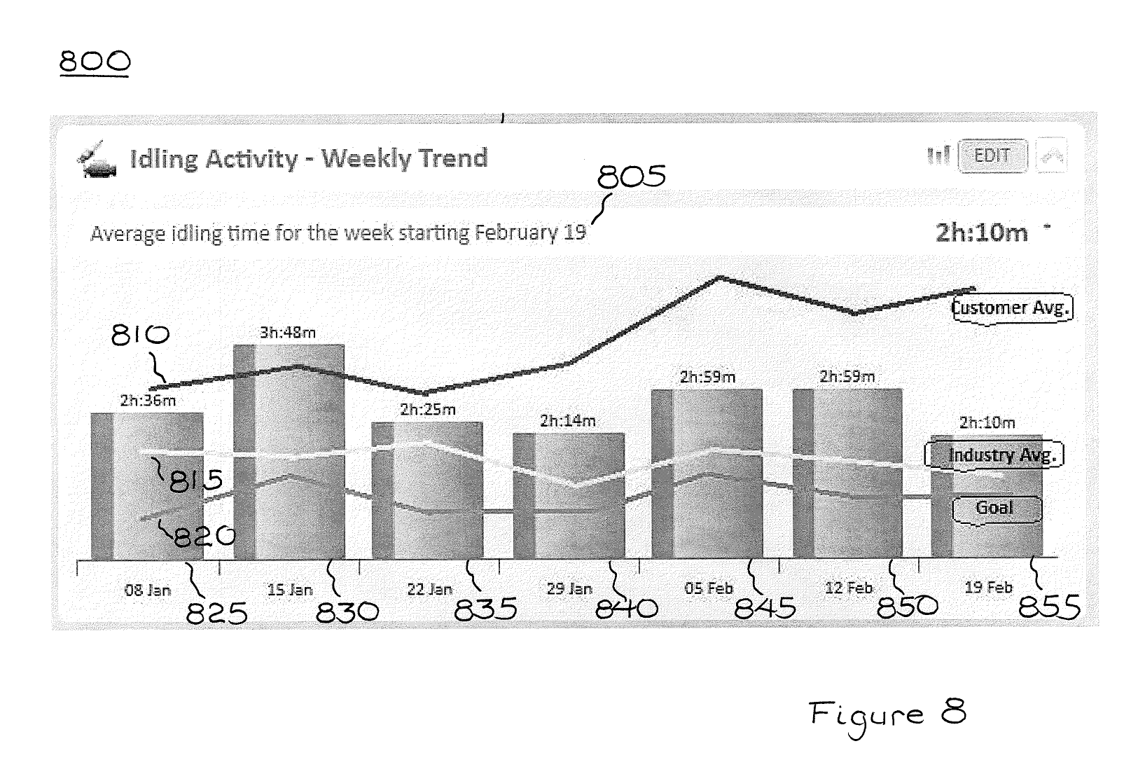

FIG. 8 shows a column chart 800 with trend lines 810-820 in accordance with the present disclosure. The column chart 800 depicts an average idle time trend over a period of time 805. Each of bars 825-855 represents the average idle time determined from sensor data received by computing devices. A line graph represents each of customer average 810, industry average 815, and goals 820. Line graphs 810-820 may make analysis or comparisons easier.

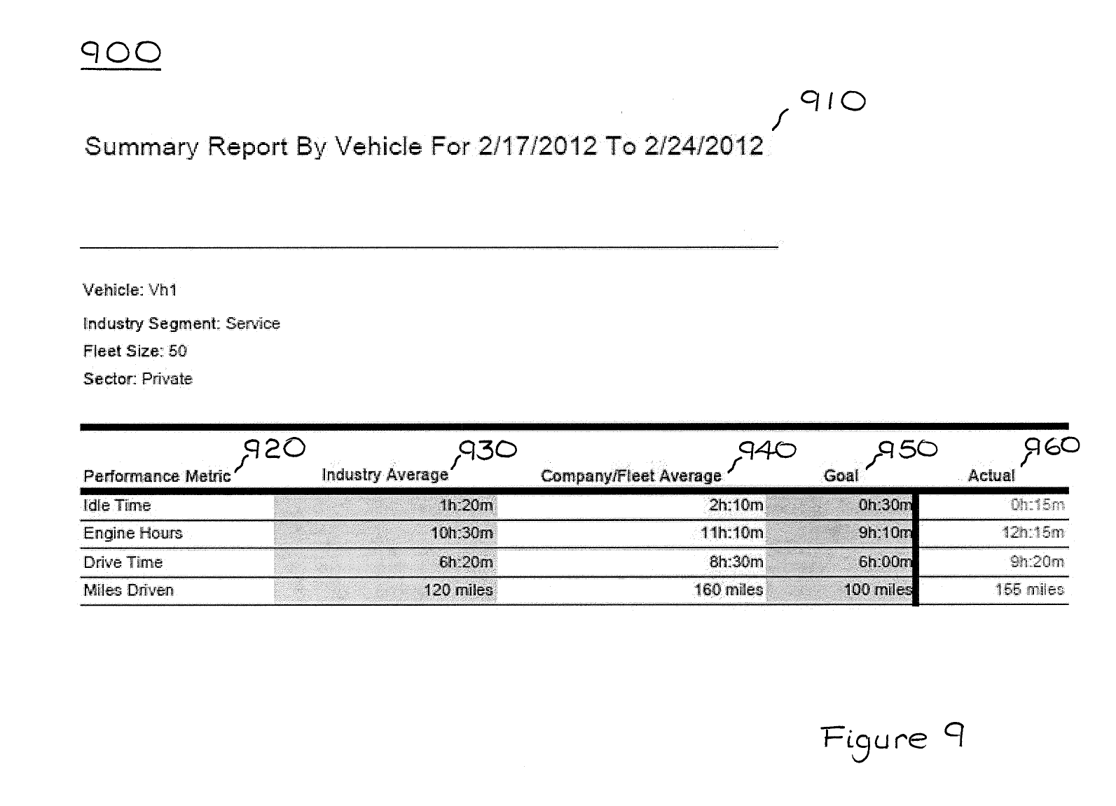

FIG. 9 depicts a spreadsheet 900 according to various embodiments of the present invention. Spreadsheet 900 presents in a tabular format an industry average 930, company/fleet average 940, goals 950, and actual values 960 for a plurality of performance metrics 920. The aggregate statistics presented in spreadsheet 900 are for a predefined time period 910.

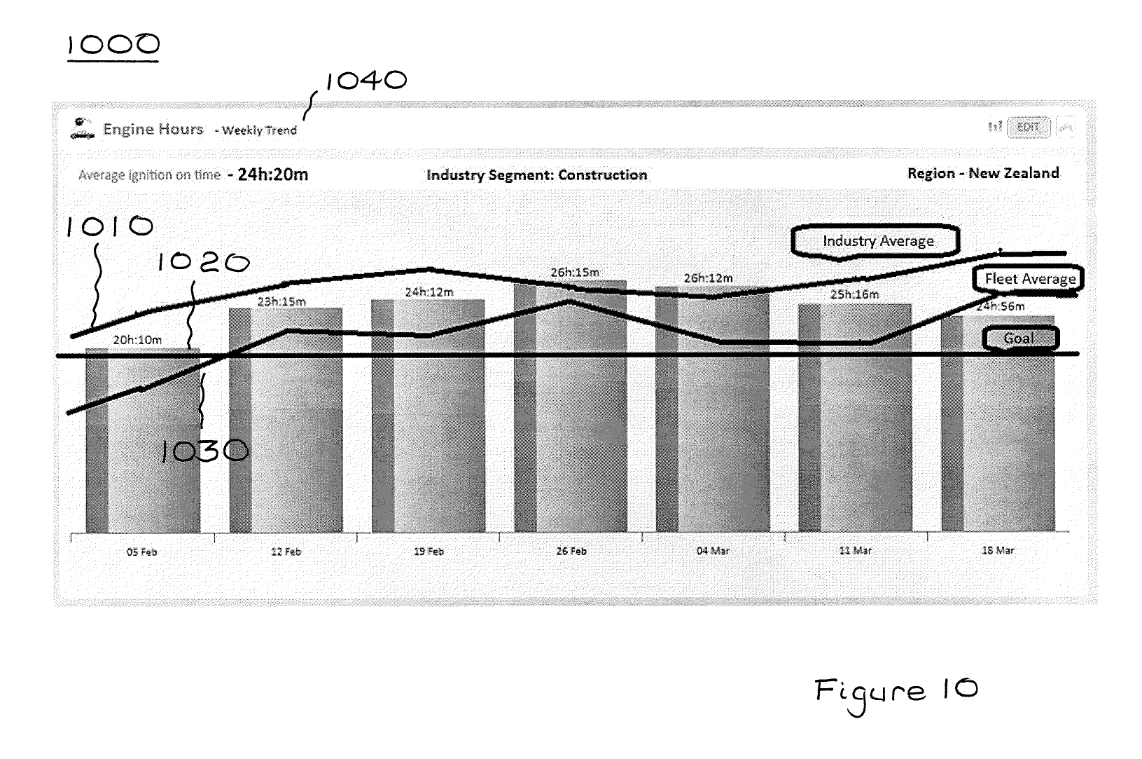

FIG. 10 represents an exemplary column chart 1000 with trend lines 1010-1030. Column chart 1000 represents an average for a performance indicator, engine hours, on a weekly basis 1040. In the example of FIG. 10, the average for engine hours is presented for a construction fleet in the New Zealand.

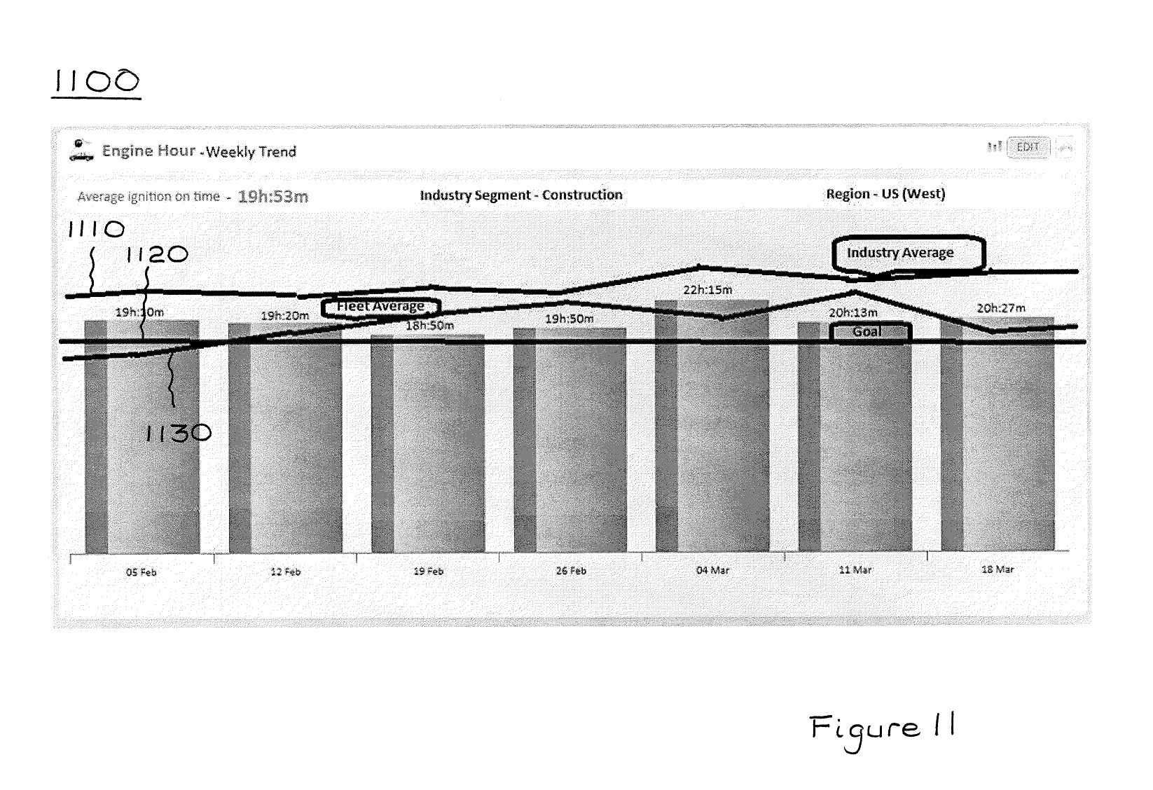

FIG. 11 portrays another exemplary column chart 1100 with trend lines 1110-1120. In the example of FIG. 11, a weekly average engine hours trend for a construction fleet in United States—Western region is presented.

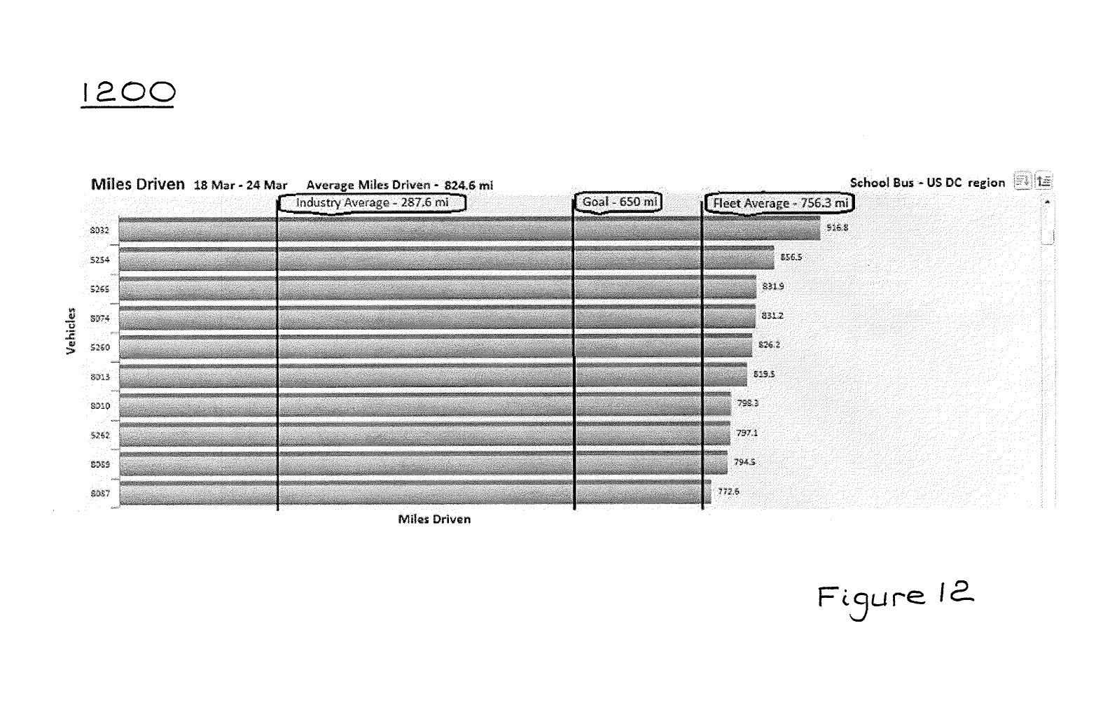

FIG. 12 illustrates an exemplary bar chart 1200. Bar chart 1200 presents averages for a performance indicator, miles driven, for a period of a week. In the example of FIG. 12, the average miles driven by a vehicle in a fleet for a week in the School Bus sector in the United States—District of Columbia region is presented.

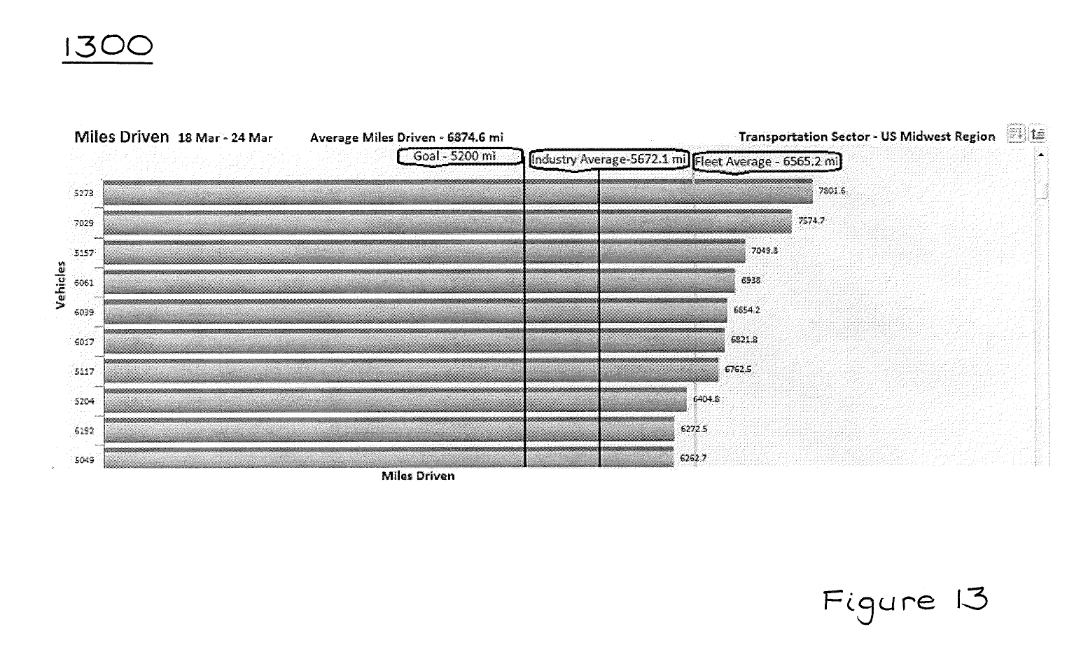

FIG. 13 shows another exemplary bar chart 1300. In the example of FIG. 13, the average the average miles driven by a vehicle for a week in the long haul transportation industry/sector in the United States Midwestern region is presented

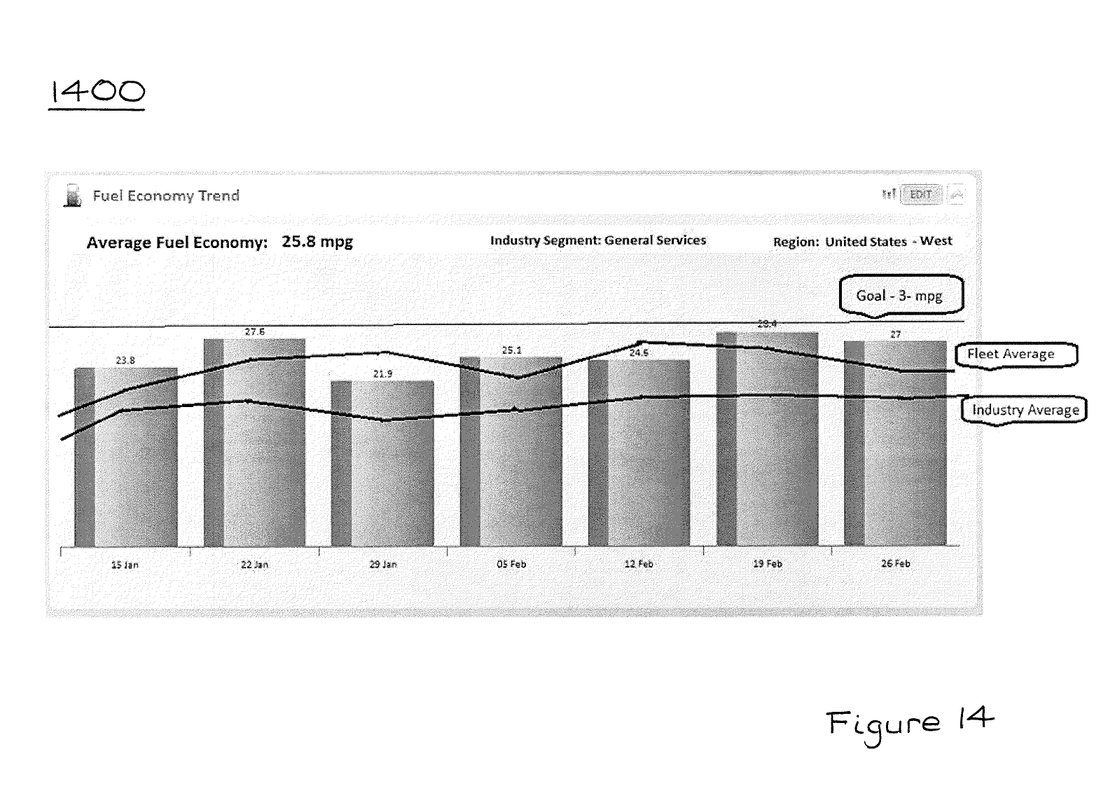

FIG. 14 depicts an exemplary column chart 1400 with trend lines. Column chart 1400 the average number of miles per gallon of fuel for a vehicle in the United States Western region General Services industry/sector is presented.

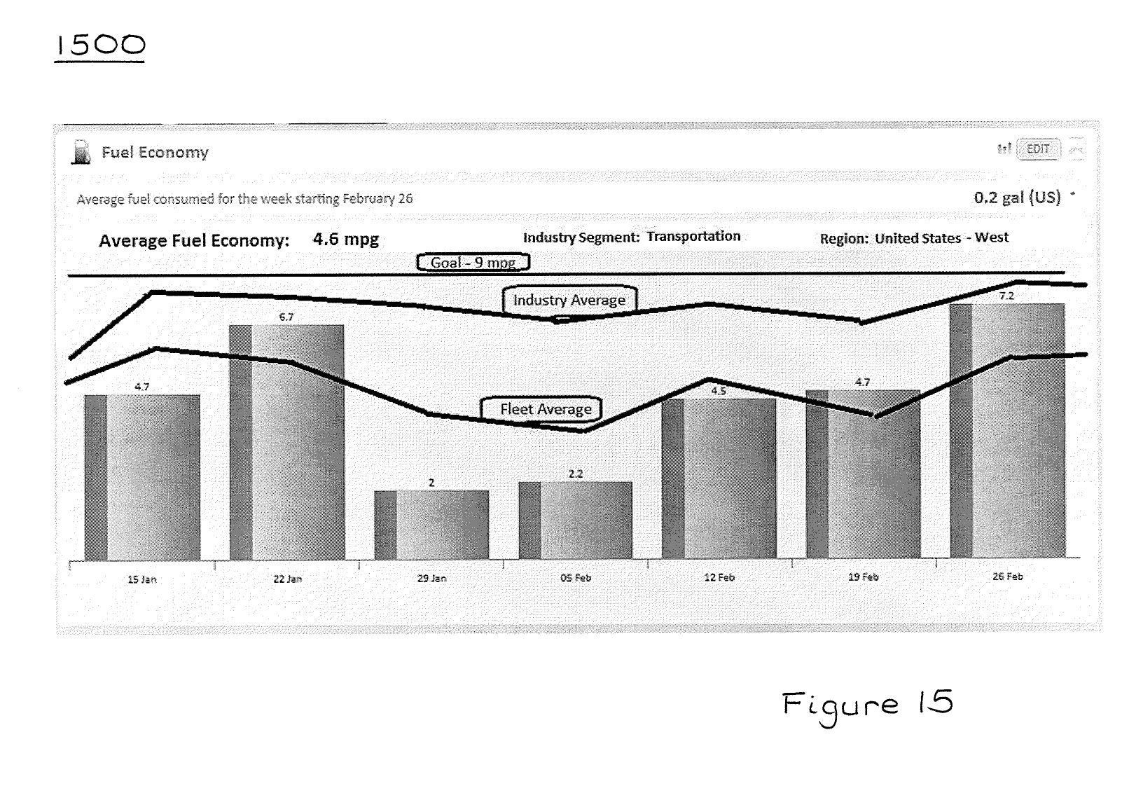

FIG. 15 represents another exemplary column chart 1500 with trend lines. In the example of FIG. 15, the average number of miles per gallon of fuel for a vehicle in the United States Western Region transportation industry/sector is presented.

While certain exemplary embodiments have been described and shown in the accompanying drawings, it is to be understood that such embodiments are merely illustrative and not restrictive of the broad disclosure and that this disclosure is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method for managing a fleet of vehicles, the method comprising:
receiving from a plurality of vehicles associated with the fleet, via executable instructions stored in a memory and executed by a processor, respective location information and sensor data;
determining, via the executable instructions, at least one performance indicator for the plurality of vehicles;
calculating, via the executable instructions, a set of statistics for the at least one performance indicator;
storing, via the executable instructions, the set of statistics;
aggregating, via the executable instructions, the set of statistics; and
generating, via the executable instructions, a report, the report including the aggregated statistics and at least one of a goal and an industry average, so as to illustrate at least one of progress toward the goal, efficacy of training, and an optimal asset allocation.

2. The method of claim 1 wherein the sensor data is received from a mobile asset.

3. The method of claim 2 wherein the sensor data is received via a wireless network.

4. The method of claim 3 wherein the sensor data is received via a message.

5. The method of claim 2 wherein the sensor data includes at least one of location information, timestamp, unique identifier, speed, acceleration, deceleration, hard cornering, ignition state, odometer data, and fuel level.

6. The method of claim 1 wherein the at least one performance indicator includes at least one of idle time, engine hours, drive time, stop time, miles driven, number of jobs completed in a predefined time period, time in yard, and fuel economy.

7. The method of claim 1 wherein the set of statistics includes at least one of a total number of data points, summation, mean, average, rolling average, standard deviation, variance, range, maximum, and minimum.

8. (canceled)

9. The method of claim 1 further comprising:
storing, via first executable instructions executed by a first processor, the sensor data in a first memory;
storing, via second executable instructions executed by a second processor, the at least one performance indicator in a second memory; and
storing, via third executable instructions executed by a third processor, the first set of statistics in a third memory.

10-12. (canceled)

13. The method of claim 1, wherein the report includes at least one of numeric data in tabular form, a column chart, a bar chart, a line chart, a pie chart, an area chart, a scatter chart, a surface chart, a bubble chart, and a doughnut chart.

14. A system for managing a fleet of vehicles, the system comprising:
a processor; and
a memory communicatively coupled with the processor, the memory storing executable instructions which when executed by the processor perform a method comprising:
receiving, from a plurality of vehicles associated with the fleet of vehicles, respective location information and sensor data;
determining at least one performance indicator for the plurality of vehicles;
calculating a set of statistics for the at least one performance indicator;
storing the set of statistics;
aggregating the set of statistics; and
generating a report, the report including the aggregated statistics and at least one of a goal and an industry average, so as to illustrate at least one of progress toward the goal, efficacy of training, and an optimal asset allocation.

15. The system of claim 14 wherein the sensor data is received from a mobile asset.

16. The system of claim 15 wherein the sensor data is received via a wireless network.

17. The system of claim 16 wherein the sensor data is received via a message.

18. The system of claim 15 wherein the sensor data includes at least one of location information, timestamp, unique identifier, speed, acceleration, deceleration, hard cornering, ignition state, odometer data, and fuel level.

19. The system of claim 14 wherein the at least one performance indicator includes at least one of idle time, engine hours, drive time, stop time, miles driven, number of jobs completed in a predefined time period, time in yard, and fuel economy.

20. The system of claim 14 wherein the set of statistics includes at least one of a total number of data points, summation, mean, average, rolling average, standard deviation, variance, range, maximum, and minimum.

21. (canceled)

22. The system of claim 14 wherein the method further comprises:
storing the sensor data in a first memory;
storing the at least one performance indicator in a second memory; and
storing the first set of statistics in a third memory.

23-26. (canceled)

27. A computer-readable storage medium having embodied thereon a program, the program being executable by a processor to perform a method for managing a fleet of vehicles, the method comprising:
receiving, from a plurality of vehicles associated with the fleet, respective location information and sensor data;
determining at least one performance indicator for the plurality of vehicles;
calculating a first set of statistics for the at least one performance indicator;
storing the set of statistics;
aggregating the set of statistics; and
generating a report, the report including the aggregated statistics and at least one of a goal and an industry average, so as to illustrate at least one of progress toward the goal, efficacy of training, and an optimal asset allocation.

28. The method of claim 1 further comprising:
receiving from an external server or a non-transitory computer-readable medium, via the executable instructions, a second set of statistics, the second set of statistics being associated with a second fleet of vehicles, the second fleet of vehicles being from at least one of a different company and a different industry than the first fleet of vehicles;
storing, via the executable instructions, the second statistics; and
aggregating, via the executable instructions, the statistics and the additional statistics.

29. The method of claim 28 wherein the second set of statistics include one or more of fuel cost, revenue per job, and a performance indicator.

30. The system of claim 14 wherein the executable instructions when executed by the processor perform a method further comprising:
receiving from an external server or a non-transitory computer-readable medium, via the executable instructions, a second set of statistics, the second set of statistics being associated with a second fleet of vehicles, the second fleet of vehicles being from at least one of a different company and a different industry than the first fleet of vehicles;
storing, via the executable instructions, the second statistics; and
aggregating, via the executable instructions, the statistics and the additional statistics.

31. The system of claim 30 wherein the second set of statistics include one or more of fuel cost, revenue per job, and a performance indicator.

32. The first non-transitory computer-readable storage medium of claim 27 further comprising:
receiving from an external server or a non-transitory computer-readable medium, via the executable instructions, a second set of statistics, the second set of statistics being associated with a second fleet of vehicles, the second fleet of vehicles being from at least one of a different company and a different industry than the first fleet of vehicles;
storing, via the executable instructions, the second statistics; and
aggregating, via the executable instructions, the statistics and the additional statistics.

33. The first non-transitory computer-readable storage medium of claim 32 wherein the second set of statistics include one or more of fuel cost, revenue per job, and a performance indicator.
